(19) United States
(12) Patent Application Publication
(10) Pub. No.: US 2008/0017141 A1
(43) Pub. Date: Jan. 24, 2008

(54) AIR/FUEL DOUBLE PRE-MIX SELF-SUPERCHARGING INTERNAL COMBUSTION ENGINE WITH OPTIONAL FREEWHEELING MECHANISM

(76) Inventor: Gile Jun Yang Park, Burnaby (CA)

Correspondence Address: OYEN, WIGGS, GREEN & MUTALA LLP;480 - THE STATION, 601 WEST CORDOVA STREET, VANCOUVER, BC, V6B 1G1, US

(21) Appl. No.: 11/758,177

(22) Filed: Jun. 5, 2007

Related U.S. Application Data
(60) Provisional application No. 60/807,896, filed on Jul. 20, 2006.

(51) Int. Cl. F02B 75/00

(52) U.S. Cl. 123/59.6

(57) ABSTRACT

The invention is directed to a novel self-supercharging internal combustion engine with two pairs of three pistons and cylinders. A self-supercharging internal combustion engine comprising: (a) a first piston and cylinder with intake and exhaust valves, the piston being connected to a crankshaft; (b) a second piston and cylinder with intake and exhaust valves, the piston being connected to the crankshaft; (c) a third piston and cylinder of a size which is at least double the size of the first and second pistons, the third piston having a valve which enables air and fuel to be drawn into the cylinder, the third cylinder being connected to the intake valves of the first and second pistons and cylinders, the third piston being connected to the same crankshaft as the first and second pistons, and a corresponding second set of three pistons and cylinders, the three pistons being connected to a second crankshaft, each crankshaft being interconnected by meshing gears. A freewheeling mechanism can be included with the first crankshaft.

### REFERENCE TO RELATED APPLICATION

This application claims the benefit of the filing date of U.S. provisional application Ser. No. 60/807,896, filed Jul. 20, 2006.

### FIELD OF THE INVENTION

The invention relates to novel designs of internal combustion engine. More particularly, this invention pertains to novel designs of air/fuel double-mix self-super-charging engines including dual crankshaft and a freewheeling mechanism which enables one or more of the pistons of the engine to be deactivated in certain operating conditions.

### BACKGROUND OF THE INVENTION

In a conventional internal combustion engine, engine wear is reduced and operational efficiency and fuel consumption are improved if engine vibration is minimized, or some of the pistons can be deactivated at certain times when full power is not required. Vibration is reduced in an engine that is dynamically balanced, but a conventional engine which has only one crankshaft and four, six or eight pistons firing in sequence, is difficult to dynamically balance. Balance can be improved if the engine has more than one crankshaft.

In a conventional internal combustion engine, the speed of the engine is measured in rotations per minute (“rpm”) of the crankshaft. Operating an engine at higher rpm means that the pistons go through more cycles. Thus the moving engine parts go through more operating cycles over a given time and engine wear is increased. Conventional internal sequential piston fired combustion engines with one crankshaft are inherently not dynamically balanced but they achieve better balancing when operating at higher rpm. The higher rpm tends to mitigate imbalance. An engine which has two crankshafts is better balanced and operates smoothly at a lower rpm. Operating at a lower rpm is advantageous because it results in less engine wear, that is, fewer operating cycles are performed in a given time. Also, less fuel is consumed.

There are a number of patents which disclose dynamically balanced internal combustion engines. Some examples of patents which disclose matched counter-rotating crankshafts are U.S. Pat. No. 2,200,744 granted to Heinzelmann (“Heinzelmann”), U.S. Pat. No. 2,596,410 granted to Le Grand L. Jordan (“Jordan”), U.S. Pat. No. 3,537,437 granted to Angelo Marius Paul (“Paul”), and U.S. Pat. No. 3,581,628 granted to Thomas V. Williams (“Williams”).

U.S. Pat. No. 3,537,437, granted Nov. 3, 1970 to Paul et al., discloses an internal combustion engine which is dynamically balanced and which achieves a highly efficient derivation of power from the combustible fuel-air mixture. The engine has all of the components which coact with the pistons during reciprocation of the latter arranged so as to form groups of components which move in synchronism while being opposed to each other so as to achieve a dynamic balance of the moving structure of the engine. In addition, the engine has various passages, spaces, and the like through which the fuel-air mixture flows during combustion, compression, and exhausting thereof, and through various valves as well as through the opposed ends of the pistons themselves the fluid is acted upon so as to achieve such features as scavenging, supercharging, and the like.

U.S. Pat. No. 5,758,610, granted Jun. 2, 1998 to Gile Jun Yang Park, discloses an air-cooled self-supercharging four stroke internal combustion engine having four pistons which move in unison. There are two downward piston strokes in each four stroke cycle. The downward strokes of the pistons are used to compress the air in the crank case and supercharge the engine by forcing the more air and fuel into the two combustion chambers. Each combustion chamber serves two piston cylinders. The compressed air and fuel mixture is forced into only one combustion chamber during each downward stroke of the pistons. The two combustion chambers are charged with air and fuel on alternating downward piston strokes. The engine is air-cooled by the flow of the combustion intake air which passes through the crank case. At the same time, heat transferred from the engine pre-heats the intake air to improve combustion efficiency. The technology disclosed in U.S. Pat. No. 5,758,610 is incorporated herein by reference.

U.S. Pat. No. 6,318,310 B1, granted Nov. 20, 2001 to Clarke, discloses a dual mode internal combustion engine which may operate in either a power mode or an efficient mode. The dual mode internal combustion engine has two four-cycle combustion chambers and a two-cycle compression/expansion chamber. The valve system is set up to introduce a fluid charge into the compression/expansion cylinder during the power mode. The fluid charge is compressed in the compression/expansion chamber and one of the combustion chambers. During the efficiency mode, the fluid charge is expanded first in one of the combustion chambers and further expanded in the compression/expansion chamber.

U.S. Pat. No. 6,553,977 B2, granted Apr. 29, 2003 to Schmitz, discloses a process of construction of a five-stroke internal combustion engine comprising especially at least one low-pressure cylinder (1) functioning in a two-stroke mode located between two high-pressure combustion cylinder (2,3) functioning in a four-stroke mode, the work chamber (C2, C3) of each combustion cylinder (2,3) being capable of communicating with the work chamber (C1) of the low-pressure cylinder (1) via a decanting valve (9) associated with the combustion cylinders (2,3) and a decanting manifold (16,17), and comprising a means of excess feeding the combustion cylinders (2,3), this process being characterized by the fact that the volume compression ratio of the combustion cylinders is relatively low, so as to be able to be highly supercharged. The invention can be used in the field of gasoline engine or Diesel engine.

U.S. Publication No. US 2006/0278181 A1, published Dec. 14, 2006, Park, discloses a four stroke internal combustion engine having two or more crankshafts, the crankshafts being separated by one or more freewheeling mechanisms so that when the engine is idling or not delivering full power, the freewheeling mechanism(s) enables one or more of the crankshafts with accompanying pistons to idle, thereby conserving fuel

Honda Motor Company produces an Odyssey i-VTEC engine which has a VCM™ mechanism that deactivates three of six cylinders during cruising and deceleration to minimize fuel consumption without compromising performance. When full power is required, the VCM activates all six cylinders.

### SUMMARY OF THE INVENTION

The invention is directed to a self-supercharging internal combustion engine comprising: (a) a first piston and cylinder with intake and exhaust valves, the piston being connected to a first crankshaft; (b) a second piston and cylinder with intake and exhaust valves, the piston being connected to the first crankshaft; (c) a third piston and cylinder of a size which is at least double the size of the first and second pistons, the third piston having a valve which enables air and fuel to be drawn into the cylinder, the third cylinder being connected in alternating manner to the intake valves of the first and second pistons and cylinders, the third piston being connected to the first crankshaft; (d) a fourth piston and cylinder with intake and exhaust valves, the piston being connected to a second crankshaft; (e) a fifth piston and cylinder with intake and exhaust valves, the piston being connected to the second crankshaft; and (f) a sixth piston and cylinder of a size which is at least double the size of the fourth and fifth pistons, the sixth piston having a valve which enables air and fuel to be drawn into the cylinder, the sixth cylinder being connected in alternating manner to the intake valves of the fourth and fifth pistons and cylinders, the sixth piston being connected to the second crankshaft, and the first and second crankshafts being connected by meshing gears.

The first piston and cylinder and the second piston and cylinder can be positioned on opposite sides of the third piston and cylinder, and the fourth piston and cylinder and the fifth piston and cylinder can be positioned on opposite sides of the sixth piston and cylinder. The first and second crankshafts can be parallel to one another.

The first crankshaft can include a freewheeling mechanism. The freewheeling mechanism can be a sprag clutch, a centrifugal clutch, a solenoid clutch, a hydraulic clutch, a pneumatic clutch, a bicycle clutch or any other acceptable clutch.

The invention can include a first fuel injector for the third piston and cylinder and second fuel injector for the sixth piston and cylinder. The invention can include spark plugs in the first, second, fourth and fifth cylinders.

The invention is also directed to a self-supercharging internal combustion engine wherein the first, second and third pistons and cylinders and the first crankshaft are aligned in a first plane and the fourth, fifth and sixth pistons and cylinders and the second crankshaft are aligned in a second plane.

The first and second crankshafts can be parallel to one another. The first and second planes can be parallel to one another.

### DRAWINGS

Exemplary embodiments are illustrated in referenced figures of the drawings. It is intended that the embodiments and figures disclosed herein are to be considered illustrative rather than restrictive.

FIG. 1 illustrates a side cut-away view of one of a pair of three-cylinder/piston self-supercharging engines during the air/fuel intake cycle of the first piston/cylinder.

FIG. 2 illustrates a side cut-away view of one of a pair of three-cylinder/piston self-supercharging engines during the air/fuel compression cycle of the first piston/cylinder.

FIG. 3 illustrates a side cut-away view of one of a pair of three-cylinder/piston self-supercharging engines during the combustion cycle of the first piston/cylinder.

FIG. 4 illustrates a side cut-away view of one of a pair of three-cylinder/piston self-supercharging engines during the exhaust cycle of the first piston/cylinder.

FIG. 5 is a front cut-away view of a pair of three cylinder/piston supercharging engines with dual crankshafts.

FIG. 6 is a top cut-away view of a pair of three cylinder/piston supercharging engines with dual crankshafts.

FIG. 7 is a front cut-away view of a pair of three cylinder/piston supercharging engines with dual crankshafts, including a freewheeling mechanism on one of the crank-shafts.

FIG. 8 is a top cut-away view of a pair of three cylinder/piston supercharging engines with dual crankshafts, including a freewheeling mechanism on one of the crank-shafts.

### DETAILED DESCRIPTION OF SPECIFIC EMBODIMENTS OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The self-supercharging internal combustion engine in a first embodiment comprises a pair of three cylinders with three reciprocal pistons connected to a respective pair of crankshafts. Two of the pistons in respective cylinders in each pair fire in alternating order while the third piston and cylinder in each pair is a supercharging piston which receives air/fuel, compresses it and delivers the compressed air/fuel to the first or second cylinders in each pair in alternating order. The size of the supercharging piston and cylinder in each pair is at least double the size of the two firing piston and cylinders in each pair in order to provide a supercharging effect. In two construction styles, the two firing pistons and cylinders in each pair can be located on either side of the supercharging piston and cylinder, or in a “V”-shaped pattern. To create higher power engines with self-supercharging effect, the number of piston/cylinders can be multiples of 6, regardless of whether an “in-line” or “V” engine orientation is used. In one embodiment, the pair of respective three pistons and cylinders, with respective crankshafts can be arranged in parallel. This pair construction provides more effective combustion, better mechanical balancing, less vibration, more power and less pollution with a small size engine. The engine can be a two-cycle engine, a fuel injection gasoline burning engine or a diesel engine with fuel injector.

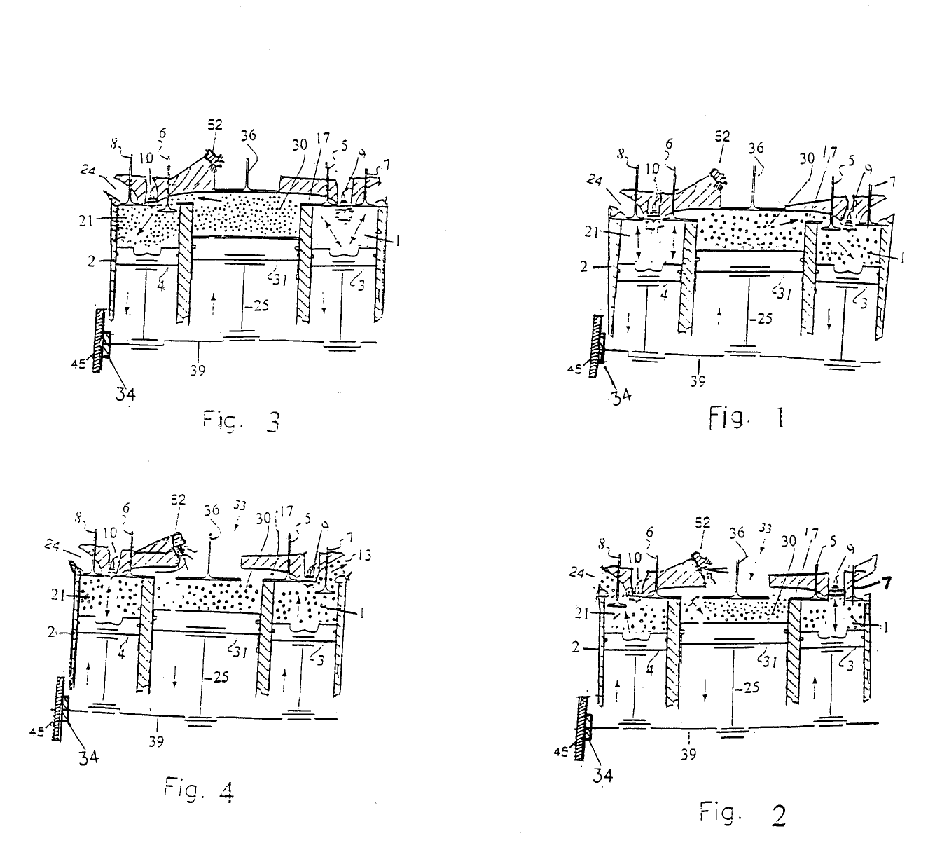

FIG. 1 illustrates a side cut-away view of one of the pair of three-cylinder/piston self-supercharging engines during the air/fuel intake cycle of the first piston/cylinder. As seen in FIG. 1, the middle cylinder 30 and piston 31 are at least twice as large as each of the adjacent cylinders 1 and 2 and respective pistons 3 and 4. This design provides a supercharging effect when compressed air/fuel is delivered from cylinder 30 to either cylinder 1 or 2, as dictated by respective valves 5 or 6. FIG. 1 also shows a fuel injector 52 over cylinder 30 and freewheeling mechanism 34 and gear 45 at the front of crankshaft 39.

As seen in FIG. 1, the operation of the three pistons and cylinders during the air/fuel intake cycle of the first piston/cylinder is described as follows:
Cylinder 1: As crankshaft 39 rotates, piston 3 moves downward. Exhaust valve 7 is closed. Air/fuel intake valve 5 is open so that compressed pre-mix air/fuel is passed into piston cylinder 1 from middle cylinder 30.
Cylinder 30: As crankshaft 39 rotates, large piston 31 moves upward. Air/fuel intake valve 36 is closed. Pre-mixed air/fuel is compressed and delivered to cylinder 1 through intake port 17 and open valve 5.
Cylinder 2: As crankshaft 39 rotates, air/fuel intake valve 6 and exhaust valve 8 are closed. Spark plug 10 is ignited at the top of cylinder 2 in area 21. A fuel injector 52 is also shown. The power generated by the ignited compressed air/fuel mixture in cylinder 2 pushes piston 4 downward.

FIG. 2 illustrates a side cut-away view of one of the pair of three-cylinder/piston self-supercharging engines during the air/fuel compression cycle of the first piston/cylinder. The operation of the three piston and cylinders during this the air/fuel compression cycle is described as follows:
Cylinder 1: As crankshaft 39 rotates, air/fuel intake valve 5 and exhaust valve 7 are closed. Piston 3 moves upward so that pre-mix air/fuel taken from cylinder 30 during the first stage shown in FIG. 1 is compressed in cylinder 1.
Cylinder 30: As crankshaft 39 rotates, middle cylinder piston 31 moves downward. Air/fuel intake valve 36 is open. Air and fuel from fuel injector 52 are injected into middle cylinder 30 through air/fuel intake port 33.
Cylinder 2: Air/fuel intake valve 6 is closed and exhaust valve 8 is open. Piston 4 moves upward. Exhaust from burnt gas in cylinder 2 is exhausted to atmosphere through exhaust port 24.

FIG. 3 illustrates a side cut-away view one of the pair of three-cylinder/piston self-supercharging engines during the combustion cycle of the first piston/cylinder. The operation of the three piston and cylinders during this combustion cycle is described as follows:
Cylinder 1: As crankshaft 39 rotates, air/fuel intake valve 5 and exhaust valve 7 are closed. Spark plug 9 ignites the compressed air/fuel mixture in combustion chamber 1. Piston 3 is forced downward by the burning air/fuel mixture.
Cylinder 30: As crankshaft 39 rotates, middle cylinder piston 31 is moving upward. Air/fuel intake valve 36 is closed. The compressed air/fuel mixture in cylinder 30 is forced into cylinder 2 through open air/fuel intake valve 6.
Cylinder 2: As crankshaft 39 rotates, piston 4 is moving downward while exhaust valve 8 is closed. Since air/fuel intake valve 6 is open, pre-mix air/fuel from cylinder 30 is delivered into cylinder 2.

FIG. 4 illustrates a side cut-away view of one of the pair of three-cylinder/piston self-supercharging engines during the exhaust cycle of the first piston/cylinder. The operation of the three pistons and cylinders during this exhaust cycle is described as follows:
Cylinder 1: As crankshaft 39 rotates, piston 3 is moving upward while air/fuel intake valve 5 is closed. Exhaust valve 7 is open so that exhaust gas 13 in cylinder 1 is vented to atmosphere.
Cylinder 30: As crankshaft 39 rotates, middle piston 31 is moving downward while air/fuel intake valve 36 is open. Air and fuel from fuel injector 52 are taken into middle cylinder 30 through open air/fuel intake port 33.
Cylinder 2: As crankshaft 39 rotates, piston 4 is moving upward while air/fuel intake valve 6 and exhaust valve 8 are closed. Air/fuel pre-mix taken previously from cylinder 30 is compressed in cylinder 2.

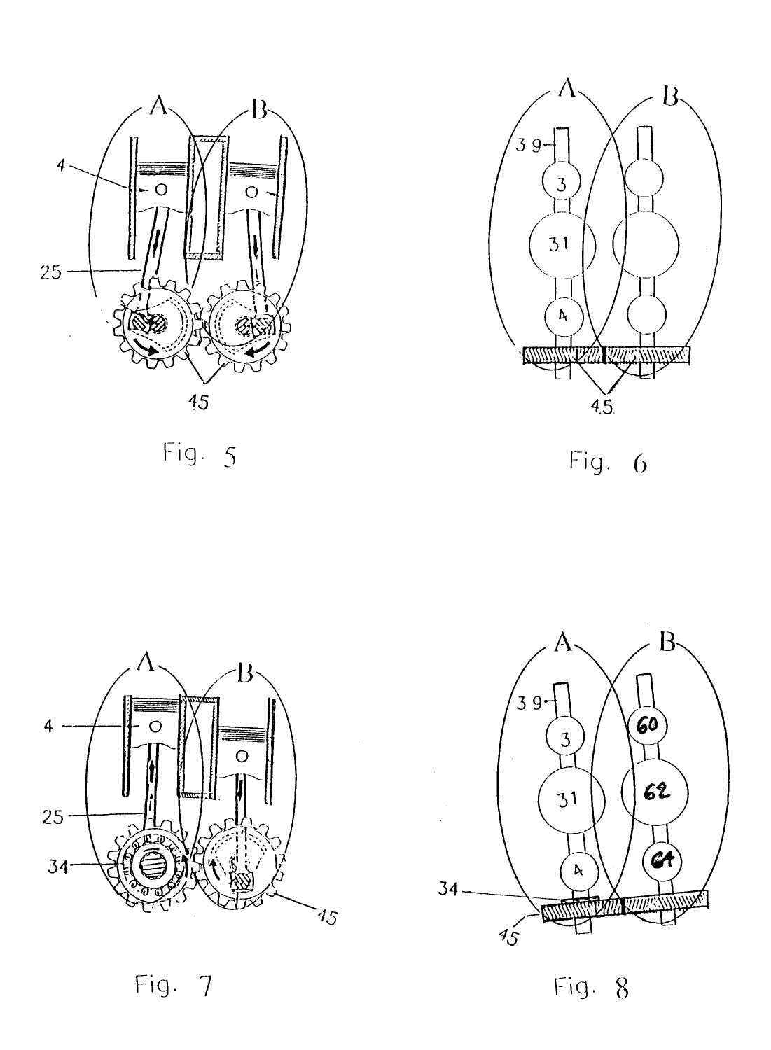

FIG. 5 is a front cut-away view of a pair of three cylinder/piston supercharging engines, identified as “A” and “B” with dual crankshafts. In FIG. 5, two sets of three piston/cylinder combinations are arranged in parallel, each connected by connecting rods 25 to separate crankshafts 39 (see FIG. 6) also arranged in parallel. The two crankshafts 39 are connected by meshing gears 45.

FIG. 6 is a top cut-away view of a parallel pair of three cylinder/piston super-charging engines with a pair of parallel crankshafts 39 and meshing gears 45 at the front of each crankshaft. This arrangement provides an efficient balanced engine.

In a second embodiment of the invention comprising two sets of three cylinders and a pair of crankshafts, FIG. 7 is a front cut-away view of a pair of three cylinder/piston supercharging engines, identified as “A” and “B”, including a freewheeling mechanism 34 on one of the crankshafts. In FIG. 7, the configuration is similar to the configuration in FIG. 5 except that one of the gears 45 has a freewheeling mechanism 34.

FIG. 8 is a top cut-away view of a pair of three cylinder/piston supercharging engines, identified as “A” and “B”, including a freewheeling mechanism 34 on one of the crankshafts 39. The two gears 45 mesh with one another.

A freewheeling mechanism is a one-way drive mechanism. Automotive Mechanics, William H. Crouse, 6th Edition, McGraw-Hill, Chapter 31, discloses a freewheeling mechanism. In a freewheeling mechanism, positive drive is provided by a first shaft or wheel on a second shaft or wheel. However, the second shaft or wheel cannot drive the first wheel or shaft. When the first shaft or wheel is slowed or stopped, the second shaft or wheel “freewheels”, and continues turning. In the context of clutches, or planetary gear sets, the freewheeling mechanism is sometimes described as an overrunning clutch. Freewheeling mechanisms can include sprag clutches, centrifugal clutches, bicycle clutches, solenoid clutches, hydraulic clutches, pneumatic clutches, or other suitable clutches.

Specifically, with the freewheeling mechanism 34 installed on the “A” crankshaft, as shown in FIGS. 7 and 8, the two pistons 60 and 64, powered by fuel injected in the air/fuel compression chamber above piston 62, drive the “B” crankshaft and this action is transferred via gear 45 to the lateral “A” crankshaft. Likewise, the two pistons 3 and 4, powered by fuel injected in the compression chamber 30 above piston 31, drive the “A” crankshaft. However, when the vehicle driven by the engine is coasting, or the engine is idling, fuel to the “B” set of three pistons is continued but fuel to the “A” set of three pistons 3, 31 and 4 is stopped and due to the freewheeling mechanism 34, the “A” set of pistons can idle, thereby conserving fuel.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A self-supercharging internal combustion engine comprising:
(a) a first piston and cylinder with intake and exhaust valves, the piston being connected to a first crankshaft;
(b) a second piston and cylinder with intake and exhaust valves, the piston being connected to the first crankshaft;
(c) a third piston and cylinder of a size which is at least double the size of the first and second pistons, the third piston having a valve which enables air and fuel to be drawn into the cylinder, the third cylinder being connected in alternating manner to the intake valves of the first and second pistons and cylinders, the third piston being connected to the first crankshaft;
(d) a fourth piston and cylinder with intake and exhaust valves, the piston being connected to a second crankshaft;
(e) a fifth piston and cylinder with intake and exhaust valves, the piston being connected to the second crankshaft; and
(f) a sixth piston and cylinder of a size which is at least double the size of the fourth and fifth pistons, the sixth piston having a valve which enables air and fuel to be drawn into the cylinder, the sixth cylinder being connected in alternating manner to the intake valves of the fourth and fifth pistons and cylinders, the sixth piston being connected to the second crankshaft, and the first and second crankshafts being connected by meshing gears.

2. A self-supercharging internal combustion engine as claimed in claim 1 wherein the first piston and cylinder and the second piston and cylinder are positioned on opposite sides of the third piston and cylinder, and the fourth piston and cylinder and the fifth piston and cylinder are positioned on opposite sides of the sixth piston and cylinder.

3. A self-supercharging internal combustion engine as claimed in claim 2 wherein the first and second crankshafts are parallel to one another.

4. A self-supercharging internal combustion engine as claimed in claim 3 wherein the first crankshaft includes a freewheeling mechanism.

5. A self-supercharging internal combustion engine as claimed in claim 4 wherein the freewheeling mechanism is a sprag clutch, a centrifugal clutch, a solenoid clutch, a hydraulic clutch, a pneumatic clutch, a bicycle clutch or any other acceptable clutch.

6. A self-supercharging internal combustion engine as claimed in claim 1 including a first fuel injector for the third piston and cylinder and second fuel injector for the sixth piston and cylinder.

7. A self-supercharging internal combustion engine as claimed in claim 1 including spark plugs in the first, second, fourth and fifth cylinders.

8. A self-supercharging internal combustion engine wherein the first, second and third pistons and cylinders and the first crankshaft are aligned in a first plane and the fourth, fifth and sixth pistons and cylinders and the second crankshaft are aligned in a second plane.

9. A self-supercharging internal combustion engine as claimed in claim 9 wherein the first and second crankshafts are parallel to one another.

10. A self-supercharging internal combustion engine as claimed in claim 8 wherein the first and second planes are parallel to one another.
